(19) United States
(12) Patent Application Publication
(10) Pub. No.: US 2010/0115858 A1
(43) Pub. Date: May 13, 2010

(54) STORM SHELTER STRUCTURE

(76) Inventor: JEFFREY D. OLSEN, Nixa, MO (US)

Correspondence Address: POLSINELLI SHUGHART PC, 700 West 47th Street, Suite 1000, KANSAS CITY, MO, 64112, US

(21) Appl. No.: 12/617,409

(22) Filed: Nov. 12, 2009

Related U.S. Application Data
(60) Provisional application No. 61/113,890, filed on Nov. 12, 2008.

(51) Int. Cl. E04H 1/12; E04H 12/00; E06B 7/02; E04B 2/08

(52) U.S. Cl. 52/79.1; 52/653.1; 49/476.1; 52/588.1

(57) ABSTRACT

A storm shelter structure provides enhanced protection from penetration by blown debris and from collapse. The shelter has an anchorable framework and door with vent openings having covers removable from the outside to enable emergency access to the door latches. Roof and wall panels are formed of channel members assembled in side-by-side relation. Each channel includes a web with flanges along opposite side edges, one flange including an outwardly extending lip. Channels are fastened side-by-side with a non-lipped flange adjacent a lipped flange. Engagement between the outer edge of a non-lipped flange and a lipped flange increases the stiffness of a rib formed by the joined flanges. Each wall channel flange upper end has a tab aligned with a tab on an adjacent channel for engaging an aperture in the upper frame to facilitate wall assembly and increase gripping between the wall panels and the framework.

### CROSS-REFERENCE TO RELATED APPLICATION

This application claims priority under 35 U.S.C. 119(e) and 37 C.F.R. 1.78(a)(4) based upon copending U.S. Provisional Application Ser. No. 61/113,890 for STORM SHELTER STRUCTURE filed Nov. 12, 2008, which is incorporated herein by reference.

### BACKGROUND OF THE INVENTION

The present invention is generally directed to improvements in storm shelters and the like and, more particularly, to construction details of such shelters constructed of formed metal elements.

Although severe storms and tornadoes can occur at virtually anyplace in the world, they are quite common in the midwestern United States. Tornadoes and “microbursts” can be damaging to any structure; however, wood frame dwellings are typically the most vulnerable to damage from such storms. Microbursts create strong downdrafts of air which are diverted to a radially outward horizontal direction when they contact the ground. The downdrafts may include very heavy rain. In addition to strong circumferential horizontal winds, tornadoes create an upward suction, the combination of which can lift roofs and entire houses from their foundations, as well as cause houses to collapse. Strong severe storm systems can include combinations of tornadoes and microbursts.

There are systems of watches and warnings for severe storms broadcast on radio and television. Additionally, outdoor sirens are activated in some areas when tornadoes have been spotted. Safety experts recommend that people take shelter when warnings broadcast or when storm sirens are heard. Taking shelter usually involves going to a room in a house which does not have an outside wall or, preferably, to a basement. Injuries in a home from severe storms, particularly tornadoes, usually involve being struck by flying or falling debris or being crushed by debris from a collapsed house. In order to avoid or reduce such injuries, various types of storm shelters have been devised.

Concrete shelters, which may be constructed above or below ground, are sturdy, long-lasting and extremely safe. However, they are costly, require substantial construction time and, once installed, cannot be relocated. So-called “saferooms” have become popular in recent years, because they can be installed either above ground on a concrete pad, or below ground in a basement. They are particularly well-suited for installation in suburban areas, where they can be positioned unobtrusively in the basement of a home without violating any homeowner association rules. However, like concrete shelters, prefabricated saferooms generally must be installed during construction of the home, while the basement is open to access from above. Because of their size, such prefabricated shelters are fairly expensive to ship and may require specialized equipment for handling and placement in a basement installation.

While these materials handling problems can be reduced by fabricating the shelter on site, shelters constructed on site may vary in quality and safety, depending on the materials employed and the method of construction. Previous on-site storm shelter construction was too complicated and time consuming for the average homeowner, but outside the experience of most home builders. While storm shelter providers could provide skilled installers, the cost of the installation would be substantially increased.

In addition, while properly constructed storm shelters effectively protect their occupants from fierce storms, debris that is hurled by the storm or deposited by collapse of adjacent building structures may block the shelter door. Such debris can prevent the occupants from exiting the shelter when the storm is over.

Accordingly, there is a need for a standardized protective shelter of uniform quality that can be safety tested and certified by a national organization, that can be provided in an easily shipped kit format for on-site assembly, and that can be easily and quickly constructed by a homeowner of average skill without assistance.

### SUMMARY OF THE INVENTION

The present invention provides an improved storm shelter construction which provides enhanced protection from penetration by blown debris and from collapse under the weight of building debris. A storm shelter according to the present invention can be supplied as an assembled shelter or as a kit for assembly on the site, such as in a basement, an inside closet, or the like.

In one embodiment, the shelter is generally formed by a rectangular framework including four vertical corner members which are joined by upper and lower pairs of side frame members, front frame members, and rear frame members. The corner members may be described as relieved or chamfered outer angle members which are reinforced by inner angle members welded or otherwise joined to the outer corner angles. The front corner members are provided respectively with door hinge members on one side and latch bolt receivers on the opposite side. The hinge members mate with hinges of a door assembly which also includes a plurality of sliding door latch bolts which can be slid into the bolt receivers to secure the door in a closed position. Preferably, the door opens inwardly to prevent it from being blocked by debris piled against the outside of the door. The door includes openings with removable cover members which provide ventilation but prevent the entry of flying debris into the interior of the shelter. The vents can be removed from the outside to enable access to the door latch bolts by rescuers, if needed. Once the shelter framework has been assembled, it can be anchored to a concrete slab, floor joists, or the like, as by bolts passing through the lower frame members of the side and rear walls. The assembly of the shelter near the location it will occupy allows components of the shelter to be easily brought through doors and up or down stairs and avoids the problems associated with carrying a bulky and very heavy completed structure through doors and on stairs.

The roof of the shelter, as well as side wall panels and a rear wall panel, are formed of sets of shallow channel members assembled in side-by-side relation. Each of the channels includes a relatively wide web with shallow flanges along opposite side edges. Each channel includes one flange which has an outwardly extending lip or shoulder. The channels are fastened together in side-by-side relation with a non-lipped flange adjacent a lipped flange, as by bolts and nuts, welding, or the like. Engagement between the outer edge of a non-lipped flange with a lipped flange increases the stiffness of a rib formed by the joined flanges.

On the channel members for the side walls and rear wall, an upper end of each of the flanges has a tab extending therefrom positioned for mutual alignment with a tab on an adjacent channel and positioned for reception in an aperture or notch formed in an upper frame member. Engagement of the tabs and apertures facilitates assembly of the side walls and rear wall and increases the gripping between the wall panels and the framework members. Ribs formed by the joined flanges of the channels forming the side and rear wall panels are directed inwardly, although it is foreseen that they could be directed outwardly. On the roof panel, the ribs are directed upwardly, although it is foreseen that they could be directed downwardly. Front and rear channels of the roof panel may have outer corners thereof relieved or chamfered to conform to the shape of the outer corner members.

While the structure of the present invention is intended primarily as a storm shelter for temporary occupation until the danger of severe storms passes, it is foreseen that it could also serve as a “safe room” or “panic room” in the event of invasion of a home by a prowler or burglar, as a security vault for safekeeping of valuable possessions and/or important documents, or as a gun safe for securing firearms.

Various objects and advantages of this invention will become apparent from the following description taken in conjunction with the accompanying drawings wherein are set forth, by way of illustration and example, certain embodiments of this invention.

The drawings constitute a part of this specification and include exemplary embodiments of the present invention and illustrate various objects and features thereof.

### BRIEF DESCRIPTION OF THE DRAWINGS

FIG. 1 is a perspective view of a storm shelter construction according to the present disclosure with parts of the roof and sidewall broken away to illustrate internal detail and one of the vent covers exploded to illustrate access to the latch bolts through the vents.

FIG. 2 is an exploded perspective view of the storm shelter construction at a reduced scale.

FIG. 3 is a perspective view of a center roof channel member.

FIG. 4 is a perspective view of a wall channel member.

FIG. 5 is an enlarged end view of the wall channel member.

FIG. 6 is a sectional view of a wall panel taken along line 6-6 of FIG. 2 and illustrating cooperation of flanges of adjacent wall channel members according to the storm shelter construction of the present disclosure.

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

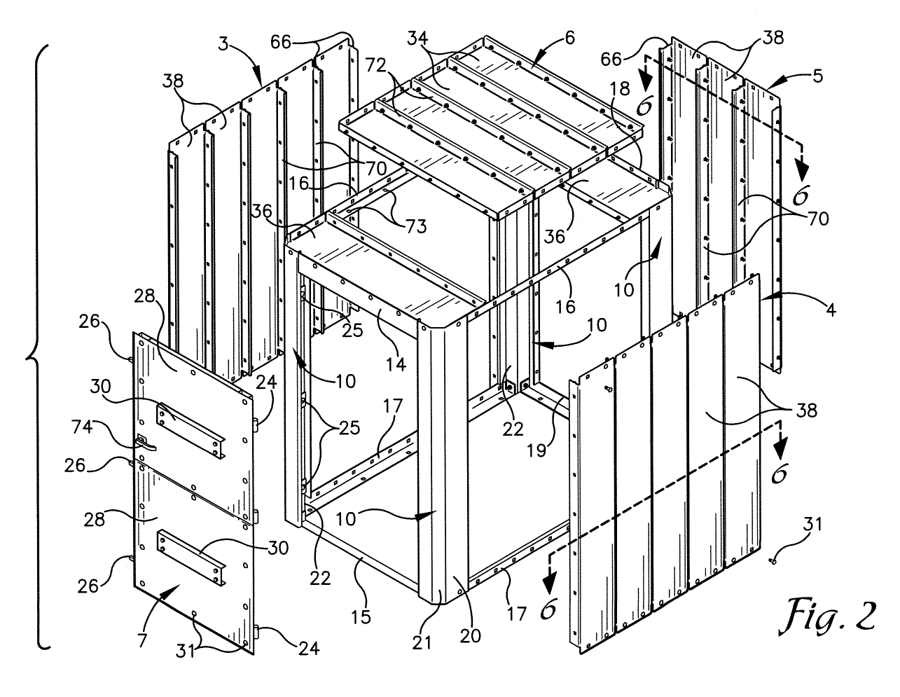

Referring now to the drawings, the reference numeral 1 generally designates a storm shelter structure according to the present invention. The illustrated structure 1 generally includes a shelter framework 2, left and right side wall panels 3 and 4, a rear wall panel 5 (FIG. 2), a roof panel 6, and a door assembly 7.

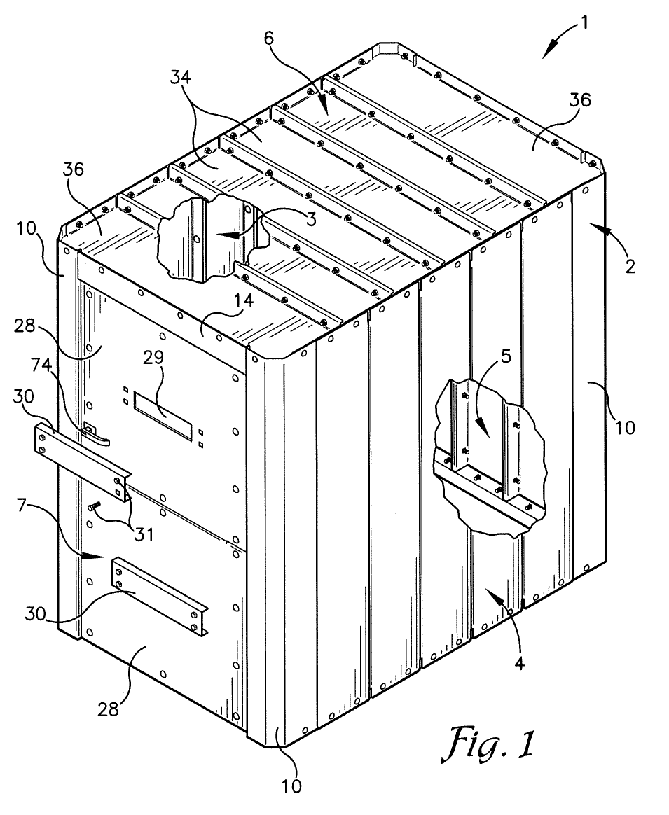

Referring to FIGS. 1 and 2, the framework 2 includes 4 corner vertical assemblies 10 connected by upper and lower front frame members 14 and 15, pairs of upper and lower side frame members 16 and 17, and upper and lower rear frame members 18 and 19. Each of the illustrated corner assemblies 10 includes an elongated vertical outer corner member 20 with a relieved, or chamfered, corner region 21 and an inner support member 22 which is joined to the outer member, as by welding, to strengthen the corner assembly 10. The upper front, side and rear frame members 14, 16 and 18 connect with respective corner assemblies 10 to form a framework for supporting the roof panel 6.

One of the front corner assemblies 10 is provided with a vertically aligned set of hinge receivers (not shown) to receive hinge members 24 (FIG. 2) of the door assembly 7. The opposite front corner assembly 10 is provided with a plurality of latch bolt receivers 25 to receive the ends of sliding door latch bolts 26 of the door assembly 7. The latch bolt receivers 25 are preferably fastened, as by welding or the use of fasteners, to the inner corner supports 22. The illustrated door 7 includes three such door latch bolts 26 which are positioned on an inner side of the door. The hinge members 24 are arranged to permit inward opening of the door 7, in order to avoid having the door blocked by debris piled against it during a storm.

The illustrated door or door assembly 7 is formed by a rectangular door frame (not shown) on which upper and lower door panels 28 are secured by bolts 31 or other suitable fasteners. Each of the door panels 28 is provided with an opening or vent 29 (FIG. 1) which depicted as having a rectangular shape and is covered by a generally channel shaped vent cover 30 which is secured by fasteners 31 positioned for removal from outside the structure. It is foreseen that the vent openings 29 and vent covers 30 may be of any suitable geometric shape such as round, oval, triangular, quadrilateral as shown or multilateral. The vent covers 30 prevent debris from flying into the interior of the structure 1, but at least a portion is open, as at the sides or ends to allow for ventilation. The door vents are positioned to enable the door latch bolts 26 to be reached from the outside through the door vents 29, as by rescuers when the door 7 has been secured. The vent covers 30 are held in place by a series of fasteners such as bolts 31, that are removable from the outside.

The roof panel 6 is formed by a plurality of shallow channel members 34 secured in side-by-side relation. Front and rear roof panels 36 are similar to the main roof channels 34, except that they have outer corners clipped or chamfered to conform to the outer corner members formed by the chamfered regions 21 of the corner assemblies 10. Channels 38 of the side wall panels 3 and 4 and rear wall panel 5 are generally similar to the roof channels 34 in most respects.

Referring now to FIG. 3, each of the roof channels 34 includes a relatively wide web 44 integrally connected with relatively narrow transverse side flanges 46 and 48 and a pair of transverse end flanges 50. The illustrated flanges 46, 48, and 50 are provided with bolt holes, illustrated as square shaped and sized to accept the shank of a bolt to facilitate assembly. One of the side flanges, such as flange 48, is provided with a shoulder forming lip 52 that extends outwardly from the flange 48 in generally transverse relation, as will be discussed further below. Flange 46 is, thus, a non-lipped flange while the flange 48 is a lipped flange.

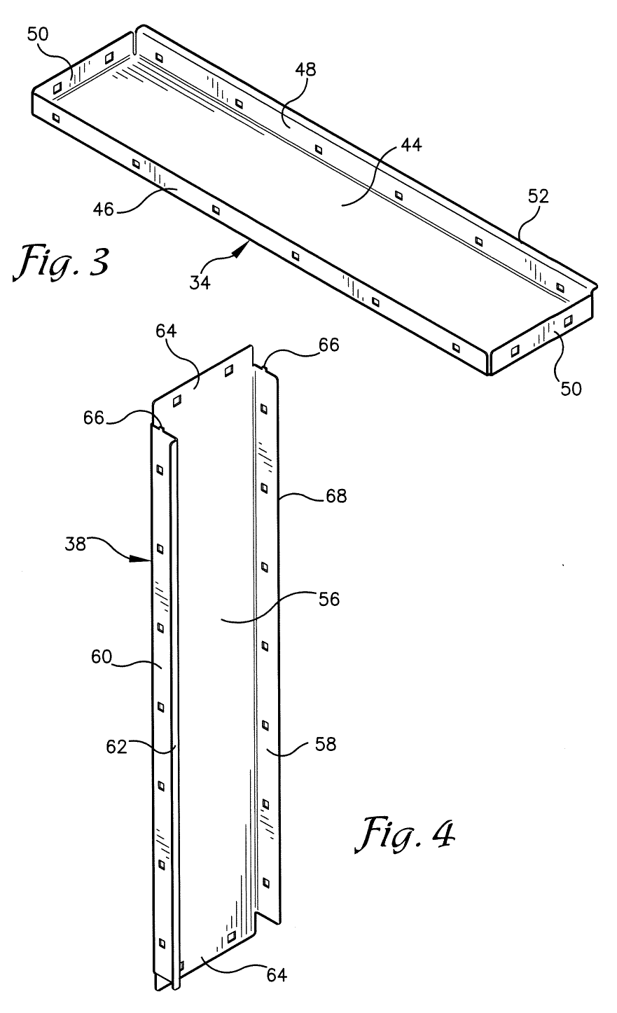

Referring to FIGS. 4 and 5, each of the side and rear wall channels 38 includes a relatively wide web 56 with relatively narrow transverse side flanges 58 and 60. The flanges 58 and 60 are provided with bolt holes for assembly of the side panels 3 and 4. Flange 60 of the illustrated channel 38 is provided with an outwardly extending, shoulder forming lip 62, that extends generally transversely from the flange 60. The flange 58 is a non-lipped flange, while the flange 60 is a lipped flange. The web 56 extends past the flanges 58 and 60 to form web ends 64 at the top and bottom ends of the channel 38 (FIG. 4). The flanges 58 and 60 are provided with tabs 66 at one, such as a top end for a purpose which will be described below. The tabs 66 are positioned on the flanges 58 and 60 for mutual alignment when the side channels 38 are assembled in side-by-side relation.

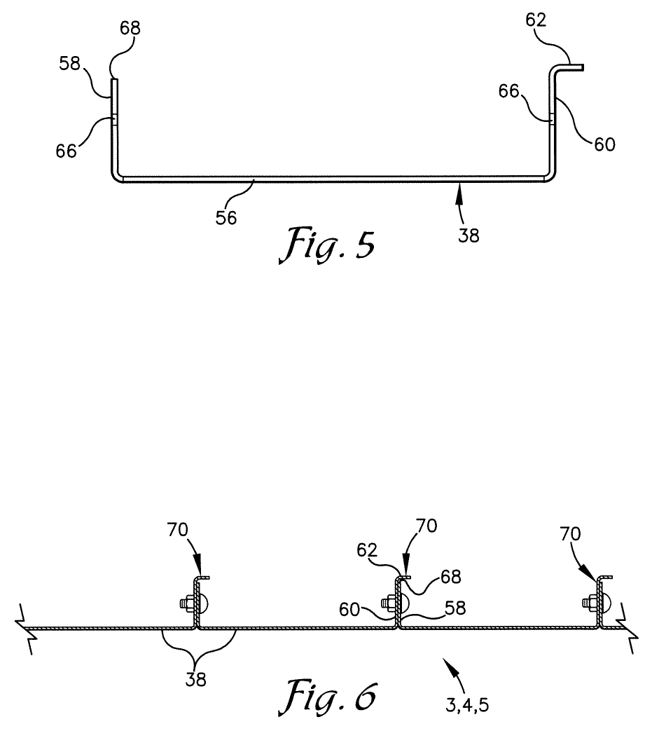

Referring to FIG. 6, the channels 38 are assembled in side-by-side relation, as by bolts 31 and nuts as illustrated, with a non-lipped flange 58 of one channel 38 adjacent a lipped flange 60 of the adjacent channel 38. When the channels 38 are thus assembled, the lip 62 of the lipped flanges 60 overlaps the outer edges 68 of the non-lipped flange 58 of the adjacent channel 38 and the outer edges 68 of the non-lipped flanges 58 engage the lip 62 of the lipped flange 60 of the adjacent channel 38. Joined flange sets 58 and 60 of adjacent channels 38 form ribs 70 for the side panels 3 and 4, which stiffen and reinforce the wall panels 3, 4 and 5. In this manner, the lip 62 of the lipped flanges 60 serves as a stop for the outer edges 68 of the non-lipped flanges 58 and the lip 62 prevents movement of the engaged non-lipped flange 58 toward the interior of the storm shelter structure when a channel 38 is forcefully struck by debris during a storm. The roof channels 34 are assembled in side-by-side relation in a manner similar to the side panels 3 and 4, with adjacent sets of the lipped and non-lipped channels 46 and 48 forming the ribs 72 (FIG. 2) of the roof panel 6.

In one embodiment of the shelter 1, the components are formed of sheet steel with the corner assemblies 10 being formed of steel stock having a thickness of about 0.25 inch (about 6 mm), while the side panels 3 and 4, the rear panel 5, and the roof panel 6 are formed of steel stock having a thickness of 11 gauge (about 0.120 inch or about 3 mm) to about 7 gauge (about 0.180 inch or about 4.6 mm). It is also foreseen that other suitable materials, such as other types of metal, for example stainless steel, prefinished galvanized steel, or synthetic resin material such as, for example, fiberglass, as well as other material dimensions could be employed.

The shelter 1 may be delivered directly to a homeowner via common carrier in the form of a kit having a manageable size and weight for do it yourself assembly by a homeowner without the need for expensive tools, equipment or hired labor. In assembling the shelter 1, the framework 2 is assembled first. The four corner assemblies 10 are stood upright and the roof framework is formed by connecting the corner assemblies 10 to the upper front, side and rear frame members 14, 16 and 18 to form a free-standing partial structure. The panels 3, 4, 5, and 6 are assembled, and a panel is selected and positioned with the tabs 66 facing upward, for alignment with the apertures 73 in one of the upper frame members 16, or 18 (the front panel member 14 will receives the door 7). As the side panels 3 and 4 and rear panel 5 are attached one-by-one to the framework 2, the aligned tabs 66 of the ribs 70 fit into the apertures 73 (FIG. 2) in the upper frame members, which holds the panels in an upright, generally vertical position and facilitates assembling the panels 3 and 4 to the framework 2.

The bottom framework is partially formed by connecting the lower side and rear members 17 and 19 to the lower ends of the corner assemblies 10. Bolts are passed through the web ends 64 of the panels 3, 4 and 5 (FIG. 4) and into the side and rear members 17 and 19 of the lower framework. Additionally, sides of the panels 3, 4, and 5 are bolted to the corner assemblies 10. Each of the front and rear roof channels 36 are attached to the upper front, side and rear frame members 14, 16 and 18 by bolts 31 through one of the channel side flanges 46 and 48 as well as by bolts through the end flanges 50. The roof panel 6 is attached to the upper side frame members 16 and to the front and rear roof channels 36 by bolts, which are accessible from outside the shelter 1 to enable removal of the roof panel 6 for rescue purposes.

Once the roof panel 6, side panels 3 and 4, and rear panel 5 have been attached, the door assembly 7 may be hung. It is foreseen that a user may proceed to hang the door assembly 7 after installing one or both of the front and rear roof channels 36 and/or the roof panel 6. The door frame (not shown) is set onto the hinges 24 on a respective interior corner support 22, and hinge pins dropped into place. The door panels 28 are bolted into place on the door frame and the vent covers 30 are bolted into place on the panels 28. The door 7 may include a latch mechanism 74 (FIGS. 1, 2) which is operable from either outside or inside of the shelter 1. The latch 74 may also be locked from the outside to secure contents within the shelter 1.

The bottom framework of the shelter is completed by bolting the lower front framework member 15 to the lower side framework members 15 and any remaining roof members 36 or 6 are bolted into place. The assembled shelter structure 1 is checked for alignment (plumb and square) and it may be moved to its desired location if it was not installed in place. The shelter 1 can be anchored into place by passing bolts through the lower frame members 17 and 19, and possibly 15, and into a concrete slab, floor joists, or other strong support structure.

Those skilled in the art will appreciate that the wall and roof panels 3, 4, 5 and 6 and channels 36 may be designed in a wide variety of lengths and widths and may also be designed for installation with the channels and ribs 70 in a horizontal orientation, rather than the vertical orientation shown and described. The channel flanges 58 and 60 may be provided with tabs 66 at the bottom end or they may be provided with tabs at both ends, with the lower frame members 17 and 19 including corresponding apertures 73. It is also foreseen that the order of assembly may be varied from that as described. In particular, it is foreseen that the corner assemblies 10 may be used to interconnect the upper frame members 14, 16 and 18 to form an upper framework and the lower frame members 15, 17 and 19 to form a lower framework before the panels 3,4,5 and 6 are attached and the door assembly 7 is hung.

In use, shelter occupants may exit the unit by removing the hinge pins if the door latch is inoperable. The door 7 may be locked from the outside, but is equipped with a bypass system to permit opening from the inside as well. The side panels 3 and 4 can be removed for egress from inside the shelter if the doorway is completely blocked by removing the bolts 31 through the flanges 58 and 60. The roof channels 34 and roof panel 6 may be removed from the outside to permit access to the occupants by rescue workers.

Shelters 1 constructed according to the present invention are particularly well suited for use as storm shelters and have been debris impact tested at Texas Tech University and wind engineer evaluated, and have been found to conform to FEMA (Federal Emergency Management Agency) standards for debris impact resistance. The shelters 1 have been certified to meet or exceed the standards and requirements of the National Storm Shelter Association (www.nssa.cc) and the International Code Council (ICC) for tornadoes and hurricanes.

The shelters 1 may also be used as a panic room for safe retreat in the event of a prowler or burglar entering the residence or business where the shelter is installed. If preferred, they may be equipped with an electronic deadbolt device. They may also be used as a security vault for valuable records or possessions, and may be fitted with cabinets or shelves to provide organized storage. They may also be used as a walk-in gun safe for securing firearms, and equipped with barrel rests and standoff supports.

It is to be understood that while certain forms of the present invention have been illustrated and described herein, it is not to be limited to the specific forms or arrangement of parts described and shown.

What is claimed and desired to be secured by Letters Patent is:

1. A shelter structure comprising:
(a) a framework anchorable to a support structure;
(b) a door engaged with said framework and operable to provide access to an interior of said structure;
(c) a plurality of panels secured to said framework to enclose said structure;
(d) each said panel being formed by a plurality of channel members, each channel member including a web with a pair of opposite side flanges, one flange of each channel member being a lipped flange including a lip extending outwardly from and along the lipped flange and an opposite flange being a non-lipped flange and having an outer edge; and
(e) said channel members of each panel being secured in side-by-side relation with a non-lipped flange of one channel member positioned in contact with a lipped flange of an adjacent channel member and with the outer edge of the non-lipped flange engaging the lip of the adjacent lipped flange.

2. The shelter structure as set forth in claim 1, wherein said door includes:
a. a vent aperture; and
b. a vent aperture cover connected to said door by fasteners positioned for removal from outside said shelter structure.

3. The shelter structure as set forth in claim 2, wherein said door includes:
a. a plurality of latch bolts mounted on an interior surface of said door and operable for securing said door to said framework; and
b. said vent aperture positioned to enable operation of said latch bolts by access through said vent aperture when said vent aperture cover is removed, for opening said door from a position outside said shelter when said door has been secured.

4. The shelter structure as set forth in claim 1, wherein:
a. said panels include a plurality of wall panels and a roof panel;
b. each of said wall panel channel member flanges includes a tab extending from an end thereof;
c. said framework includes a plurality of tab receiving apertures; and
d. said wall panels are secured to said framework with said tabs of said channel members engaging said tab receiving apertures.

5. The shelter structure as set forth in claim 1, wherein said engaged lipped and non-lipped flanges cooperatively form a plurality of support ribs between said adjacent channel members of each said panel.

6. The shelter structure as set forth in claim 5, wherein:
a. said panels include a plurality of wall panels and a roof panel;
b. said wall panels are secured to said framework in an orientation with said support ribs facing inwardly; and
c. said roof panel is secured to said framework in an orientation with said support ribs facing outwardly for enabling disengagement of said flanges and removal of said channels members from a position outside said shelter.

7. The shelter structure as set forth in claim 1, wherein said lip of said lipped flange of an adjacent channel member serves as a stop against movement of said engaged non-lipped flange toward the interior of said shelter structure when said channel is struck by debris during a storm.

8. A shelter structure comprising:
(a) a plurality of frame members assembled to form a framework capable of being anchored to a support structure;
(b) a door assembly engaged with said framework and operable to enable access to an interior of said structure;
(c) a roof panel secured to said framework;
(d) a plurality of wall panels, each wall panel being formed by a plurality of channel members joined in side-by-side relation, each channel member including a web with a pair of opposite side flanges, each flange having a tab extending from an end thereof;
(e) selected frame members of said framework having tab receiving apertures formed therein; and
(f) said wall panels being secured to said framework with the tabs of said wall panels engaging said tab receiving apertures in said selected frame members.

9. The shelter structure set forth in claim 8, wherein said framework includes an upper portion and a lower portion interconnected by a plurality of corner assemblies, each corner assembly including:
a. an outer corner member; and
b. an inner corner support engaging an inner surface of said outer corner member.

10. The shelter structure as set forth in claim 9, wherein said outer corner members each include a chamfered region for relieving the corners thereof.

11. The shelter structure as set forth in claim 8, wherein said door assembly includes:
a. a vent aperture; and
b. a vent aperture cover connected to said door assembly by fasteners positioned for removal from outside said shelter structure.

12. The shelter structure as set forth in claim 9, wherein:
a. one of said inner corner supports includes a plurality of latch bolt receivers; and
b. said door assembly includes a plurality of latch bolts operable for engagement with said latch bolt receivers.

13. The shelter structure as set forth in claims 8, wherein:
a. said wall panels are each formed by a plurality of channel members, each channel member including a web with a pair of opposite side flanges, one flange of each channel member being a lipped flange including a lip extending outwardly from and along the lipped flange and an opposite flange being a non-lipped flange hand having an outer edge; and
b. said channel members of each panel being secured in side-by-side relation with a non-lipped flange of one channel member positioned in contact with a lipped flange of an adjacent channel member and with the outer edge of the non-lipped flange engaging the lip of the adjacent lipped flange.

14. The shelter as set forth in claim 13, wherein said engaged lipped and non-lipped flanges cooperatively form a plurality of support ribs between said adjacent channel members of each said panel.

15. The shelter structure set forth in claim 8, wherein said framework includes upper and lower frame members interconnected by corner assemblies, said lower frame member including a plurality of apertures for receiving fasteners for anchoring said shelter to a support surface.

16. The shelter structure set forth in claim 9, wherein said upper framework portion includes said tab receiving apertures.

17. A kit for assembling a saferoom comprising:
a. a plurality of upper and lower frame members, selected ones of the upper frame members including tab receiving apertures and selected ones of the lower frame members including apertures for anchoring the lower frame members to a support surface, and a plurality of corner assemblies, each corner assembly having an outer corner member and an inner corner support member, one of the inner corner support members including a plurality of latch bolt receivers;
b. a door assembly having a door framework, a door panel connectable to said door framework, the door panel having a vent aperture, a vent cover connectable to said door panel, and a door latch bolt;
c. a plurality of channel members, each channel member including a web with a pair of opposite side flanges, one flange of each channel member being a lipped flange including a lip extending outwardly from and along the lipped flange and an opposite flange being a non-lipped flange and having an outer edge;
d. said channel members being secured in side-by-side relation with a non-lipped flange of one channel member positioned in contact with a lipped flange of an adjacent channel member and with the outer edge of the non-lipped flange engaging the lip of the adjacent lipped flange to form a door panel when the saferoom structure is assembled; and
e. selected ones of said channel members being wall panel channel members with each flange having a tab extending from an end thereof for reception into said tab receiving apertures when said saferoom structure is assembled.
